(19) United States
(12) Patent Application Publication
(10) Pub. No.: US 2010/0157750 A1
(43) Pub. Date: Jun. 24, 2010

(54) DEFECT DETECTING METHOD AND SYSTEM FOR OPTICAL DISC

(76) Inventors: Shih-Hsin Chen, Hsinchu County (TW); Chih-Yuan Wang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/343,511

(22) Filed: Dec. 24, 2008

(51) Int. Cl. G11B 20/10

(52) U.S. Cl. 369/47.14; G9B/20.009

(57) ABSTRACT

A defect detecting method for an optical disc accessed by an optical pickup head, including: (a) detecting if any defect exists in a detected region of the optical disc after data is written to the detected region; (b) while writing data to the optical disc, detecting if any defect exists on the optical disc according to reflection from the optical pickup head to thereby generate a first defect detecting result; and (c) switching from one of the steps (a) and (b) to the other of the steps (a) and (b).

### BACKGROUND OF THE INVENTION

1. Field of the Invention

The present invention relates to a defect detecting method for an optical disc and system, and particularly relates to a defect detecting method for an optical disc and system that operate the detecting methods according to different situations.

2. Description of the Related Art

FIG. 1 is a schematic diagram illustrating a related art “All Verify” method. As shown in FIG. 1, a specific amount of data will be verified (error detected) after the data is written to the detected region X of the optical disc, and then reads back the data on the optical disc to compare with the original data. The defect indicates that the data written to the optical disc is different from the original data to be written, and the defect is regarded as existence when amount of the difference reaches a threshold level. The specific amount of data to be verified (i.e. the size of detected region X) depends on a buffer for buffering data. Also, if errors are detected in the detected region X, the data can be written to another position of the optical disc, if necessary.

It should be noted that FIG. 1 is only schematic diagram for describing the operations of the “All Verify” method and do not mean that the data writing step and verifying step should be performed in a straight region of the optical disc. Practically, the data writing step and verifying step are performed on the tracks of the optical disc.

The above-mentioned method has advantage and disadvantage. The “All Verify” method has high accuracy but low speed. Thus a method or apparatus to improve the defect detection is needed.

### SUMMARY OF THE INVENTION

One embodiment of the present invention discloses a defect detecting method for an optical disc accessed by an optical pickup head, including: (a) detecting if any defect exists in a detected region of the optical disc after data is written to the detected region; (b) while writing data to the optical disc, detecting if any defect exists on the optical disc according to reflection from the optical pickup head to thereby generate a first defect detecting result; and (c) switching from one of the steps (a) and (b) to the other of the steps (a) and (b).

Another embodiment of the present invention discloses an optical disc defect detecting system, which includes: an optical pickup head arranged to access an optical disc; a data error detector arranged to read data from a detected region of the optical disc and detecting if any data error exists after the data is written to the detected region; a defect detector arranged to detect if any defect exists on the optical disc according to reflection from the optical pickup head to thereby generate a first defect detecting result, while writing data to the optical disc; and a control unit arrange to switch the optical disc defect detecting system from one of a first mode and a second mode to the other of the first mode and the second mode; wherein the optical disc defect detecting system utilizes the data error detector in the first mode and utilizes the first and the defect detector in the second mode.

According to the above-mentioned embodiments, the defect detecting method can be selected according to requirements, and thus the convenience increases accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a related art “All Verify” method.

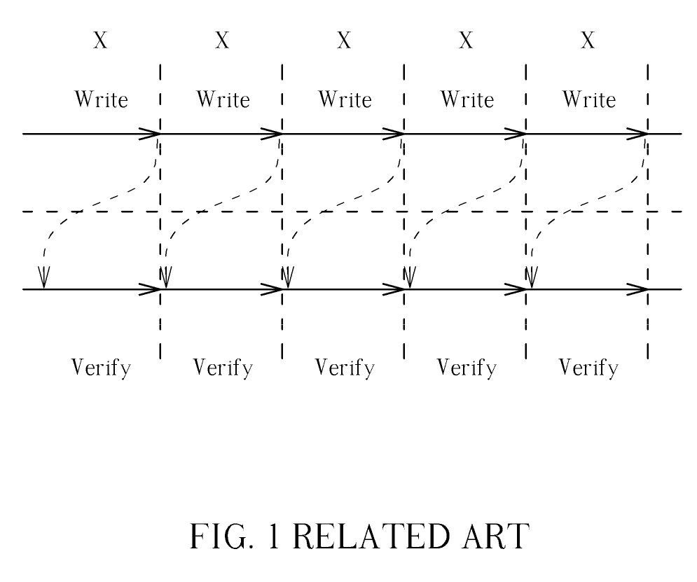

FIG. 2 is a schematic diagram illustrating “Smart Verify” method of the present invention.

FIG. 3 is a flow chart illustrating a defect detecting method for an optical disc according to a preferred embodiment of the present invention.

FIG. 4 is a block diagram illustrating a defect detecting system for an optical disc according to a preferred embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

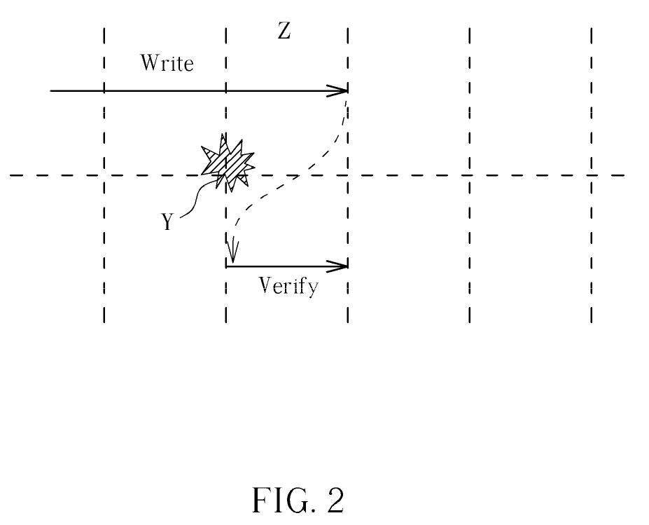

FIG. 2 is a schematic diagram illustrating a related art “Smart Verify” method. In this case, the defect is detected according to a signal from the optical pickup head (e.g. a laser that derives from the optical pickup head and is reflected from the optical disc) while writing data to the optical disc. The error thus is detected (e.g. at point Y) and decided by reflection of the laser from the optical disc. Moreover, when detects the error, the data writing operation stops for a period of time, and the data on surrounding region (such as the region Z) of the error is read back for further confirmation to improve the accuracy. After that, the data writing operation keeps going. Otherwise, if the error (or defect) is not detected, the writing operation will not stop.

It should be noted that FIG. 2 is only schematic diagram for describing the operations of the “Smart Verify” method and do not mean that the data writing step and verifying step should be performed in a straight region of the optical disc. Practically, the data writing step and verifying step are performed on the tracks of the optical disc.

However, the “Smart Verify” method has high speed, but the accuracy thereof depends on the quality of the signal reflected from the optical pickup head. Thus, the defect detection can be improved according to different situations.

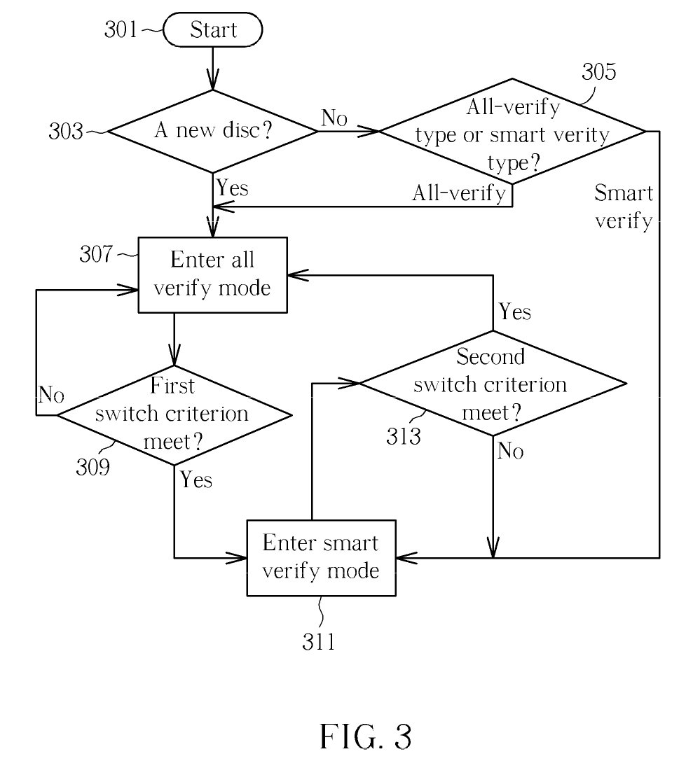

FIG. 3 is a flow chart illustrating a defect detecting method for an optical disc according to a preferred embodiment of the present invention. It should be noted that FIG. 3 is only an example and is not meant to limit the scope. As shown in FIG. 3, the method starts at step 301. Step 303 decides if the optical disc to be processed is a new optical disc, or a previously processed optical disc. If the optical disc was processed before, it can be recorded which of the “Smart Verify Mode” and the “All Verify Mode” is suitable for the optical disc. Step 305 determines which one of the “Smart Verify Mode” and the “All Verify Mode” should be utilized. If the “All Verify Mode” is utilized, go to step 307. Otherwise, if the “Smart Verify Mode” is utilized, go to step 311.

It should be note that the “Smart Verify Mode” or the “All Verify Mode” utilized in step 305 is depended on some rules. For example, when the disc can be identified as a disc with good write quality by disc ID, the defect detecting method utilizes the “Smart Verify Mode” first, otherwise, utilizes the “All Verify Mode”. Moreover, when the disc can be identified the verify mode used last time or before, the defect detecting method utilizes the verify mode from results of the identification. Typically, if there is no special concern, the defect detecting method takes the “All Verify Mode” first to ensure the write quality.

When entering “All Verify Mode” first in step 307, a first switch criterion is determined to be met or not in a following Step 309, and switches from the “All verify Mode” to the “Smart Verify Mode” accordingly. The first switch criterion can be determined as the following description. First, counts defect amount according to the defects detected in the detected region when the “All Verify Mode” is performed, and then the method switches from the “All verify Mode” to the “Smart Verify Mode” according to the defect amount. Specifically, the defect amount is compared with a predetermined value, and the “All verify Mode” is switched to the “Smart Verify Mode” when the defect amount is less than the predetermined value. It means that the optical disc has fewer defects, and doesn't need such high accuracy verification by “All Verify” method. In other words, the first switch criterion in step 309 means that the defect amount is smaller than a predetermined value.

When entering “Smart Verify Mode” first in step 311, a second switch criterion is determined to be met or not in a following Step 313, and switches from the “Smart Verify Mode” to the “All verify Mode” accordingly. The second switch criterion can be determined as the following description. First, counts defect amount according to the defects detected in the detected region when the “Smart Verify Mode” is performed, and then the method switches from the “Smart verify Mode” to the “All Verify Mode” according to the defect amount. Specifically, the defect amount is compared with a predetermined value, and the “Smart verify Mode” is switched to the “All Verify Mode” when the defect amount is more than the predetermined value. It means that the optical disc has more defects, and needs high accuracy verification by “All Verify” method. In other words, the second switch criterion in step 313 means that the defect amount is larger than a predetermined value.

Moreover, the detected region has several ECC (error correction code) blocks, and “All Verify Mode” accumulates ECC blocks each having at least a defect to generate the defect amount.

It is noted that switching between these two modes, “Smart verify Mode” and the “All Verify Mode”, is not only depends on the criterion about the amount of error detected. The following description takes second switch criterion for example to illustrate other implement ways, and the description about first switch criterion is omitted for brevity.

The second switch criterion also can be implemented by comparing a first defect detecting result with a second defect detecting result, wherein the first defect detecting result is derived according to the reflection of the laser from the optical disc, and the second defect detecting result is derived according to the data read from the surrounding region of the error. Switch from the “Smart Verify Mode” to the “All Verify Mode” if a comparing result indicates that a difference (such as amount, amount during a specific period, or location of the defects) between the first defect detecting result and the second defect detecting result reaches a threshold value (or standard). That is, if the difference reaches a threshold value, it means that the “Smart Verify Mode” is not accurate enough and should therefore be switched back to the “All Verify Mode”.

When the “Smart Verify Mode” is performed, the switching step for switching from the “Smart Verify Mode” to the “All Verify Mode” can be determined to be performed or not according to other conditions. For example, the switching step can be determined according to the data amount written to the optical disc in the “Smart Verify Mode”. Additionally, the switching step also can be determined according to whether a region where data to be written on the optical disc exceeds a threshold value or reaches a selected region while performing the “Smart Verify Mode”. That is, it depends on whether the written track length of the optical disc exceeds a predetermined value. Additionally, the switching step can be determined according to whether the “Smart Verify Mode” is performed for a predetermined time.

Moreover, the switching step also can be determined according to writing speed (i.e. recording speed). It means that when the writing speed changes, the switching between the “Smart Verify Mode” and the “All Verify Mode” is decided accordingly.

It should be noted that the above-mentioned conditions for switching one of the “Smart Verify Mode” and the “All Verify Mode” to the other one (i.e. the second switch criterion ) are only examples and are not meant to limit the scope of the present invention. The switching step between the “Smart Verify Mode” and the “All Verify Mode” can be determined according to any other condition, which also falls within the scope of the present invention.

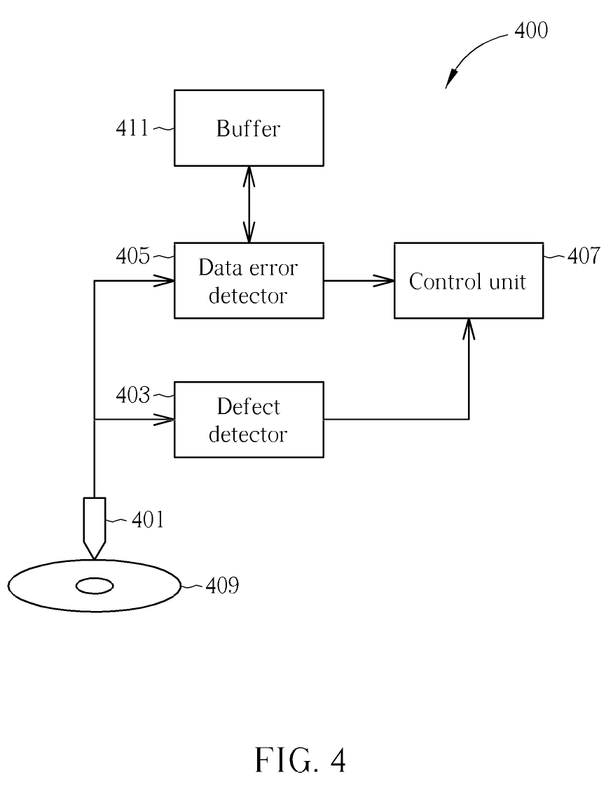

FIG. 4 is a block diagram illustrating a defect detecting system 400 for an optical disc according to a preferred embodiment of the present invention. As shown in FIG. 4, the optical disc defect detecting system 400 includes an optical pickup head 401, a defect detector 403, a data error detector 405 and a control unit 407. The optical pickup head 401 is used for accessing an optical disc 409. The defect detector 403 is used for detecting if any defect exists on the optical disc 409 according to a signal generated from reflection of laser that is emitted by the optical pickup head 401 to thereby generate a first defect detecting result, while writing data to the optical disc 409. The data error detector 405 is used for reading data from a detected region of the optical disc 409 and detecting if any data error (i.e. defect) exists after the data is written to the detected region to thereby generate a second defect detecting result.

The control unit 407 is used for switching the optical disc defect detecting system 400 between different modes. The optical disc defect detecting system 400 utilizes the data error detector in the “All Verify Mode” and utilizes the data error detector and the defect detector in the “Smart Verify Mode”.

The data error detector 405 can be a decoder or a comparator (not shown). Besides the switching operation, the control unit 407 can further perform operations such as generating a defect amount according to defects detected in the detected region via: comparing the defect amount with a predetermined value; and comparing the first defect detecting result and the second defect detecting result to generate a comparing result, as in the above-mentioned step 313.

Additionally, the optical disc defect detecting system 400 can further include a buffer 411, which is used for buffering the data for verifying steps shown in FIG. 2.

Other detailed operations and characteristics of the defect detecting system 400 can be easily obtained via the embodiment shown in FIG. 3. They are therefore omitted here for brevity.

According to the above-mentioned embodiments, the detecting method can be selected according to different situations, and the convenience thus increases accordingly.

Those skilled in the art will readily observe that numerous modifications and alterations of the device and method may be made while retaining the teachings of the invention.

What is claimed is:

1. A defect detecting method for an optical disc accessed by an optical pickup head, comprising:
(a) detecting if any defect exists in a detected region of the optical disc after data is written to the detected region;
(b) while writing data to the optical disc, detecting if any defect exists on the optical disc according to reflection from the optical pickup head to thereby generate a first defect detecting result; and
(c) switching from one of the steps (a) and (b) to the other of the steps (a) and (b).

2. The method of claim 1, wherein the step (a) further comprises generating a defect amount according to defects detected in the detected region; and the step (c) comprises:
when the step (a) is currently performed for detecting defects on the optical disc, selectively switching from the step (a) to the step (b) according to the defect amount.

3. The method of claim 2, wherein selectively switching from the step (a) to the step (b) according to the defect amount comprises:
comparing the defect amount with a predetermined value; and
switching from the step (a) to the step (b) when the defect amount is less than the predetermined value.

4. The method of claim 3, wherein the detected region includes a plurality of ECC (error correction code) blocks, and the step (a) accumulates ECC blocks each having at least a defect to generate the defect amount.

5. The method of claim 1, further comprising:
(d) detecting if any defect exists in a detected region that is already detected via the step (b) to generate a second defect detecting result;
(e) comparing the first defect detecting result and the second defect detecting result; and
(f) switching from the step (b) to the step (a) if a comparing result of the step (e) indicates that a difference between the first defect detecting result and the second defect detecting result reaches a threshold value.

6. The method of claim 1, wherein the step (c) further comprises switching from the step (b) to the step (a) when data amount written to the optical disc exceeds a threshold value while performing the step (b).

7. The method of claim 1, wherein the step (c) further comprises switching from the step (b) to the step (a) when a region where data to be written on the optical disc exceeds a threshold value or reaches a selected region while performing the step (b).

8. The method of claim 1, wherein the step (c) further comprises switching from the step (b) to the step (a) when a writing speed changes while performing the step (b).

9. The method of claim 1, wherein the step (c) further comprises switching from the step (b) to the step (a) if the step (b) is performed for a predetermined time.

10. An optical disc defect detecting system, comprising:
an optical pickup head arranged to access an optical disc;
a data error detector arranged to read data from a detected region of the optical disc and detecting if any data error exists after the data is written to the detected region;
a defect detector arranged to detect if any defect exists on the optical disc according to reflection from the optical pickup head to thereby generate a first defect detecting result, while writing data to the optical disc; and
a control unit arrange to switch the optical disc defect detecting system from one of a first mode and a second mode to the other of the first mode and the second mode;
wherein the optical disc defect detecting system utilizes the data error detector in the first mode and utilizes the first and the defect detector in the second mode.

11. The optical disc defect detecting system of claim 10, wherein the data error detector is a decoder or a comparator.

12. The optical disc defect detecting system of claim 10, wherein the control unit further generates a defect amount according to defects detected in the detected region, and the control unit selectively switches the optical disc defect detecting system from the first mode to the second mode according to the defect amount.

13. The optical disc defect detecting system of claim 12, wherein the control unit compares the defect amount with a predetermined value, and switches the optical disc defect detecting system from the first mode to the second mode when the defect amount is less than the predetermined value.

14. The optical disc defect detecting system of claim 13, wherein the detected region includes a plurality of ECC (error correction code) blocks, and the control unit accumulates ECC blocks each having at least a defect to generate the defect amount.

15. The optical disc defect detecting system of claim 10, wherein the data error detector read data from the detected region to generate a second defect detecting result, where the control unit compares the first defect detecting result and the second defect detecting result to generate a comparing result and switches the optical disc defect detecting system from the second mode to the first mode if the comparing result indicates that a difference between the first defect detecting result and the second defect detecting result reaches a threshold value.

16. The optical disc defect detecting system of claim 10, wherein the control unit further switches the optical disc defect detecting system from the second mode to the first mode when data amount written to the optical disc exceeds a threshold value.

17. The optical disc defect detecting system of claim 10, wherein the control unit further switches the optical disc defect detecting system from the second mode to the first mode when a region where data to be written on the optical disc exceeds a threshold value or reaches a selected region.

18. The optical disc defect detecting system of claim 10, wherein the control unit further switches the optical disc defect detecting system from the second mode to the first mode when a writing speed changes.

19. The optical disc defect detecting system of claim 10, wherein the control unit further switches the optical disc defect detecting system from the second mode to the first mode when the optical disc defect detecting system operates in the second mode for a predetermined time.
